(19) United States
(12) Patent Application Publication
(10) Pub. No.: US 2015/0172173 A1
(43) Pub. Date: Jun. 18, 2015

(54) COMMUNICATION SYSTEM, COMMUNICATION APPARATUS AND PATH SWITCHING METHOD

(71) Applicant: FUJITSU LIMITED, Kawasaki-shi (JP)

(72) Inventor: Yasuyuki Mitsumori, Kawasaki (JP)

(73) Assignee: Fujitsu Limited, Kawasaki (JP)

(21) Appl. No.: 14/551,919

(22) Filed: Nov. 24, 2014

(30) Foreign Application Priority Data
Dec. 16, 2013 (JP) 2013-259610

(51) Int. Cl. H04L 12/703

(52) U.S. Cl. CPC H04L 45/28

(57) ABSTRACT

There is provided a communication system including a first communication apparatus configured to connect a first path of a first network with a second network, and a second communication apparatus configured to connect a second path of the first network with the second network, wherein the first communication apparatus is configured to notify the second communication apparatus of a status of the first path, and wherein the second communication apparatus is configured to transfer, to the second network, data transferred on the second path, based on the notified status of the first path.

### CROSS-REFERENCE TO RELATED APPLICATION

This application is based upon and claims the benefit of priority from the prior Japanese Patent Application No. 2013-259610 filed on Dec. 16, 2013, the entire contents of which are incorporated herein by reference.

### FIELD

The embodiments discussed herein are related to a communication system, a communication apparatus and a path switching method.

### BACKGROUND

In recent years, with the widespread of the Internet or mobile communication, trends in communication is rapidly shifting from a conventional TDM (Time Division Multiplexing) based network to a packet based network using Ethernet (registered trademark) or IP (Internet Protocol). A demand for path redundancy in which a logical path over which various frames are transmitted is made redundant or apparatus redundancy in which the communication apparatus is made redundant, is increasing in the packet based network in order to improve reliability or serviceability. For example, Japanese Laid-Open Patent Publication No. 2012-191329 discloses a redundant network system in which a relaying apparatus between different segments is made redundant, and both an active path and a standby path are connected to each relaying apparatus so as to allow communication service to be continued even when multiple failures occur.

However, in the technology described above, when a failure occurs in one relaying apparatus, it is needed to switch both the active path and the standby path connected to a relaying apparatus in which the failure has occurred to an active path and a standby path connected to the other relaying apparatus. In this technology, the redundancy configuration is simply duplicated and the path redundancy configuration and the apparatus redundancy configuration are unable to be used jointly.

### SUMMARY

Accordingly to an aspect of the invention, a communication system includes a first communication apparatus configured to connect a first path of a first network with a second network, and a second communication apparatus configured to connect a second path of the first network with the second network, wherein the first communication apparatus is configured to notify the second communication apparatus of a status of the first path, and wherein the second communication apparatus is configured to transfer, to the second network, data transferred on the second path, based on the notified status of the first path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view for explaining a redundancy configuration in a P2P (Point to Point) network;

FIG. 2 is a view for explaining a redundancy configuration in a MP2MP (Multi-Point to Multi-Point) network;

FIG. 3A is a view for explaining the point that may occur when networks providing different types of services are connected by a single path;

FIG. 3B is a view for explaining the point that may occur when networks providing different types of services are connected with each other through a path extension;

FIG. 4 is a view illustrating an example of connection between networks providing different types of services at normal times;

FIG. 5A is a view illustrating an example of connection between networks providing different types of services when a failure occurs in an LANSW apparatus 10a;

FIG. 5B is a view illustrating an example of connection between networks providing different service when a failure occurs in an access SW apparatus 32;

FIG. 6A is a view illustrating a physical configuration of a network to which the apparatus redundancy technology according to the present embodiment is applied;

FIG. 6B is a view illustrating a logical configuration of the network to which the apparatus redundancy technology according to the present embodiment is applied;

FIG. 7 is a view illustrating an exemplary configuration of a communication system 1;

FIG. 8 is a view illustrating an example of data stored in a RFTB (Reception Frame Table) 11b of an IF card 11;

FIG. 9A is a view illustrating an example of data stored in a redundant path status management table 11d before a failure occurs in an active path P1;

FIG. 9B is a view illustrating an example of data stored in the redundant path status management table 11d after a failure occurs in the active path P1;

FIG. 10 is a view illustrating an example of data stored in a RFTB (Reception Frame Table) 12b of an IF card 12;

FIG. 11 is a view illustrating a PID information format PF;

FIG. 12A is a view illustrating an example of data stored in a PIDT (PID Table) 12e before a failure occurs in the active path P1;

FIG. 12B is a view illustrating an example of data stored in the PIDT 12e after a failure occurs in the active path P1;

FIG. 13 is a view illustrating an example of data stored in a RFTB (Reception Frame Table) 13b of an IF card 13;

FIG. 14A is a view illustrating an example of data stored in a PIDT (PID Table) 22e before a failure occurs in the active path P1;

FIG. 14B is a view illustrating an example of data stored in the PIDT 22e after a failure occurs in the active path P1;

FIG. 15A is a view illustrating an intra-apparatus frame format FF1;

FIG. 15B is a view illustrating a path management frame format FF2; and

FIG. 16 is a view illustrating a flowchart for explaining a frame destination determination process executed by a path redundancy switching control unit 11c of the IF card 11 of the communication apparatus 10.

### DESCRIPTION OF EMBODIMENTS

Hereinafter, descriptions will be made on embodiments of a communication system, a communication apparatus and a path switching method in which improvement of a fault tolerance may be achieved in a plurality of network in detail with reference to the drawings. Further, the communication system, the communication apparatus and the path switching method disclosed in the present disclosure are not limited to the embodiments. In the following, the MP2MP (Multi-Point to Multi-Point) network and the P2P (Point to Point) network are exemplified, but the present disclosure is not limited thereto. Further, as a premise of the description, path termination in the present embodiment refers to a conversion between electrical signal and optical signal.

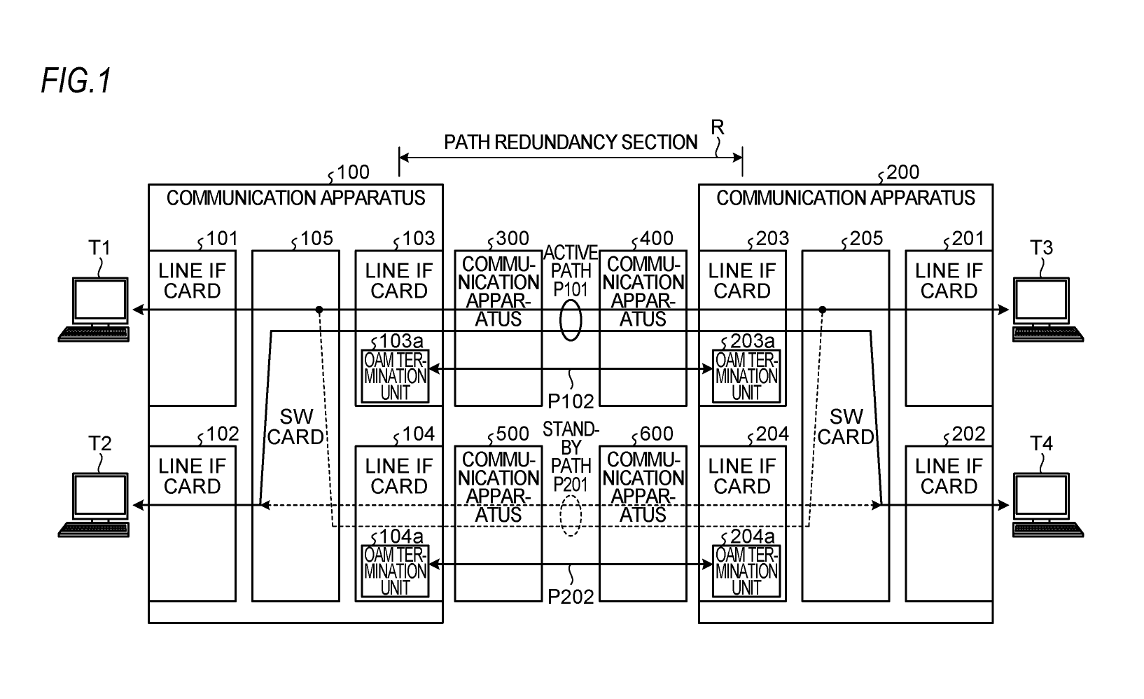

FIG. 1 is a view for explaining a redundancy configuration in a P2P (Point to Point) network. As illustrated in FIG. 1, an active path and a standby path are set as logical redundant paths between the communication apparatus 100 to which terminals T1 and T2 are connected and the communication apparatus 200 to which terminals T3 and T4 are connected.

The path redundancy configuration illustrated in FIG. 1 is one to one connection scheme, and thus, a user frame is transmitted to one of the active path and the standby path. That is, the user frame is normally transmitted over an active path P101 represented by a solid line and is not transmitted over a standby path P201.

Further, an OAM (Operation Administration Maintenance) frame which is a path monitoring frame is regularly transmitted and received in a path redundancy section R between the communication apparatus 100 and the communication apparatus 200 in order to monitor the normality between the active path P101 and the standby path P201. Accordingly, for example, when a failure occurs in the active path P101, the communication apparatuses 100 and 200 may detect the occurrence of the failure by a receiving end of the OAM frame. Each line IF (InterFace) cards 101, 102, 201 and 202 switches a transmission destination of the user frame from the previous active path P101 to the standby path P201 after detection of the failure. As a result, communications between the terminals T1 to T4 may be maintained even after the occurrence of the failure.

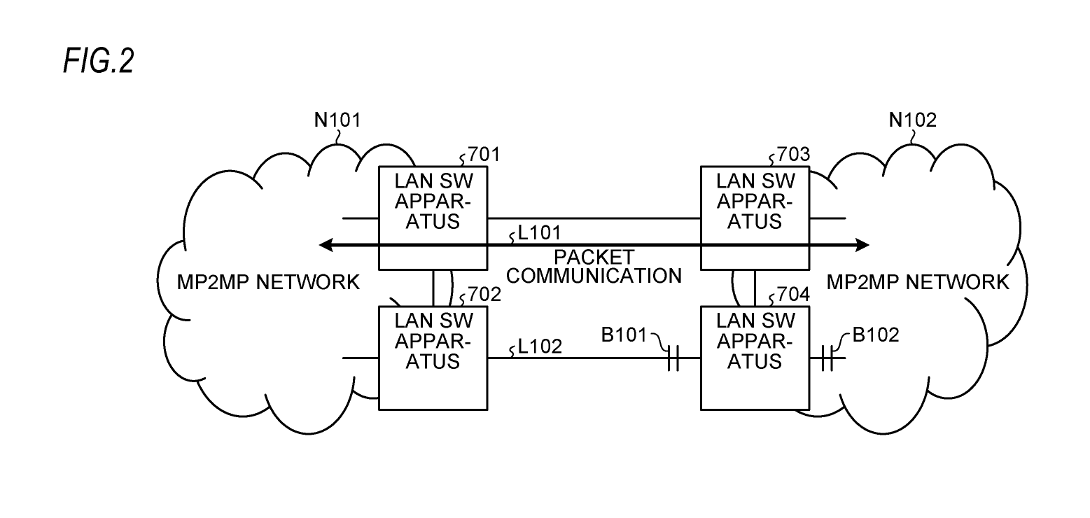

FIG. 2 is a view for explaining a redundancy configuration in a MP2MP (Multi-Point to Multi-Point) network. In FIG. 2, each of LANSW (Local Area Network SWitch) apparatuses 701, 702, 703 and 704 is equipped with the STP (Spanning Tree Protocol) and normally, a blocking port B101 is set at a line L102 side of the LANSW apparatus 704 so as to avoid the occurrence of the loop in a packet communication route. For example, when the failure occurs at the LANSW apparatus 703 of an MP2MP network N102 side during the packet communication through the line L101, BPDU (Bridge Protocol Data Unit) packet is not transmitted from the LANSW apparatus 703 to the LANSW apparatus 704. Therefore, the STP of the LANSW apparatus 704 changes the blocking port B101 which was set at the line L102 side to a forwarding port. Thereafter, the packet communication between the MP2MP networks N101 and N102 is maintained using the line L102.

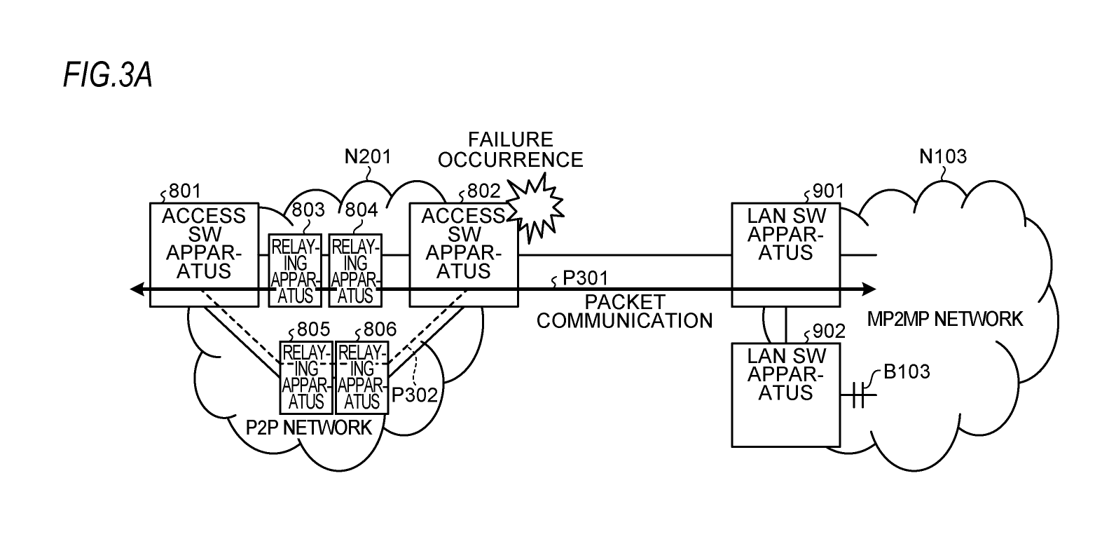

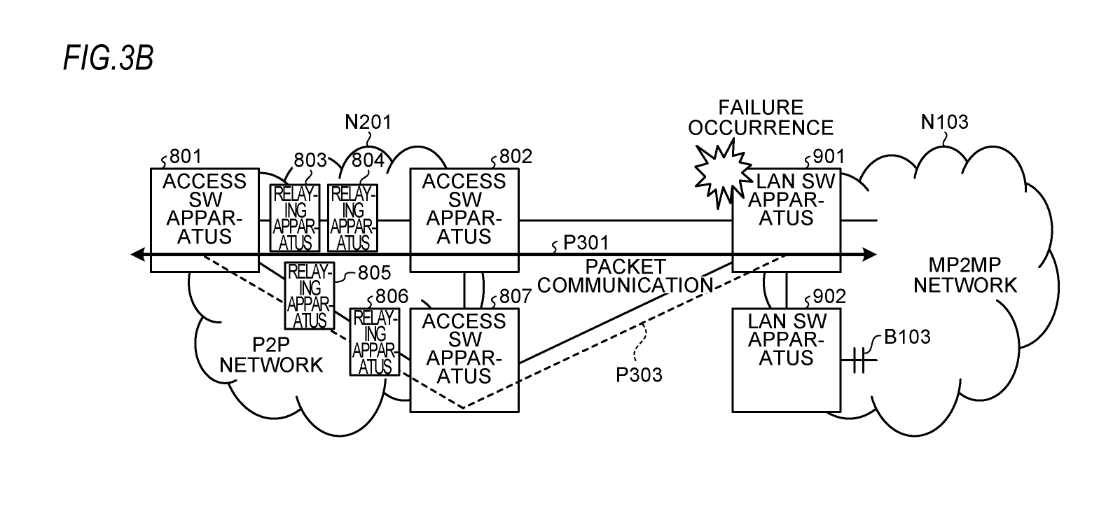

FIG. 3A is a view for explaining the point that may occur when networks providing different types of services are connected by a single path. In FIG. 3A, the P2P network N201 and the MP2MP network N103 are connected by a path P301. The P2P network N201 is an access network which is a lower layer network aggregating user lines and the MP2MP network N103 is a core network or backbone network such as the LAN, which is an upper layer network.

Access SW (SWitch) apparatuses 801 and 802 within the P2P network N201 are different from LANSW apparatuses 901 and 902 and are not equipped with the STP. Accordingly, the access SW apparatuses 801 and 802 are equipped with, for example, G.8031 technology and, as a result, is made path redundant. However, even though the path redundancy is improved, since the connection between interconnection points of respective networks is not made through the apparatus redundancy, communication between the networks is not maintained when a failure occurs in a communication apparatus such as, for example, the access SW apparatus 802, which constitutes corresponding interconnection point.

FIG. 3B is a view for explaining the point that may occur when networks providing different types of services are connected with each other through the path extension. As illustrated in FIG. 3B, when the redundant paths (the active path P301 and the standby path P303) within the P2P network N201 are extended to the MP2MP network N103 side, the communication between the networks is maintained by the path redundancy even when a failure occurs in one of the access SW apparatuses 802 and 807. However, when the failure occurs in the communication apparatus (e.g., LANSW apparatus 901) which constitutes the interconnection point of the MP2MP network N103 side, communication between the networks is not maintained.

The interconnection points of both networks with coexistence of the MP2MP network N103 of the communication service provider side and P2P network N201 of the user terminal side is needed to exist in order to implement a cost reduction while maintaining the reliability of service using the network. Therefore, increasing the fault tolerance in each interconnection point of the networks which provide different types of services is the principal point to be solved from a point of view of service improvement for the user. That is, an effective measure in providing the user with higher and more reliable service is to enable the apparatus redundancy connection not only between the networks providing the same service but also between the networks providing different types of services.

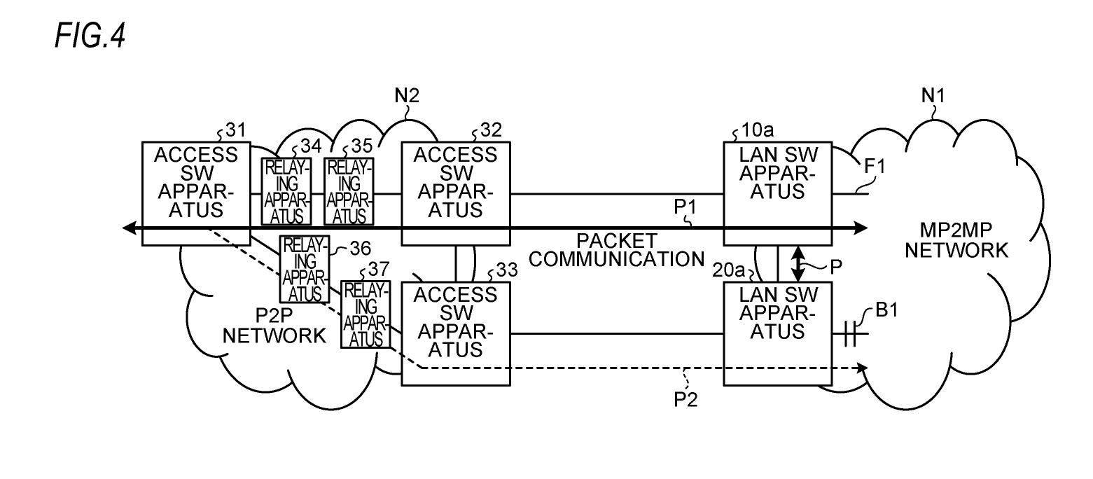

Hereinafter, descriptions will be made on a configuration of the communication system according to an embodiment disclosed in the present disclosure. FIG. 4 is a view illustrating an example of connection between networks providing different types of services at normal times. As illustrated in FIG. 4, the path redundancy connection is made by the active path P1 and the standby path P2 in the P2P network N2. The active path P1 and the standby path P2 are terminated by different apparatuses at the termination points of the path redundancy, respectively.

In this case, each of the LANSW apparatuses 10a and 20a may periodically transmit and receive the path management frame P for notifying the status of each of redundant paths P1 and P2 with each other to share a newest status of path between apparatuses at all times. The LANSW apparatuses 10a and 20a may use the shared information to switch the path between the redundant paths P1 and P2. Accordingly, the apparatus redundancy connection is implemented between the networks providing different types of services as well. Further, when a failure occurs in one LANSW apparatus, the path management frame P which has been received periodically is not received in the other LANSW apparatus. In this case, the other LANSW apparatus determines that the failure has occurred and performs a path switching. As described above, the path management frame P is periodically transmitted through the apparatus redundancy connection, so that communications may be continued even when the failure occurs in one of the LANSW apparatuses.

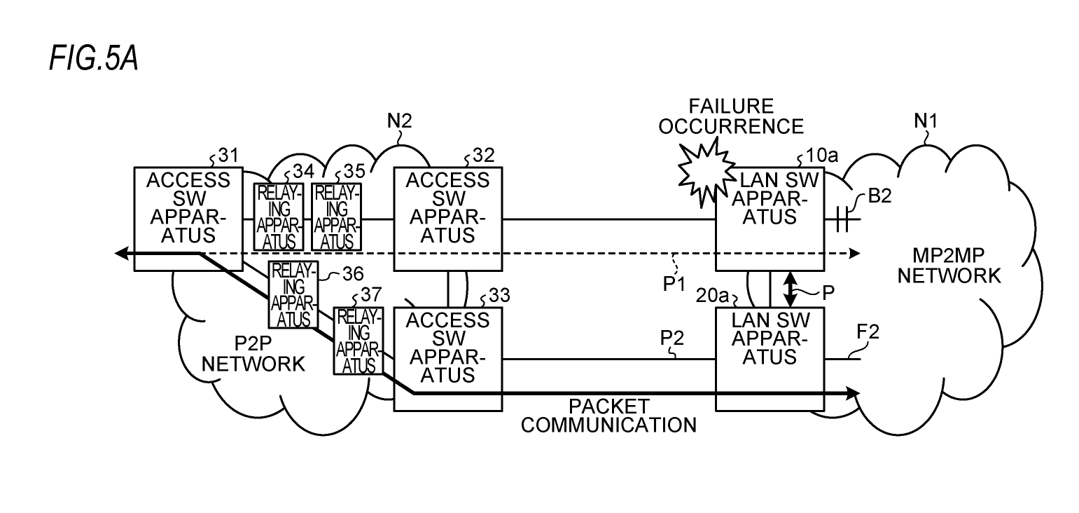

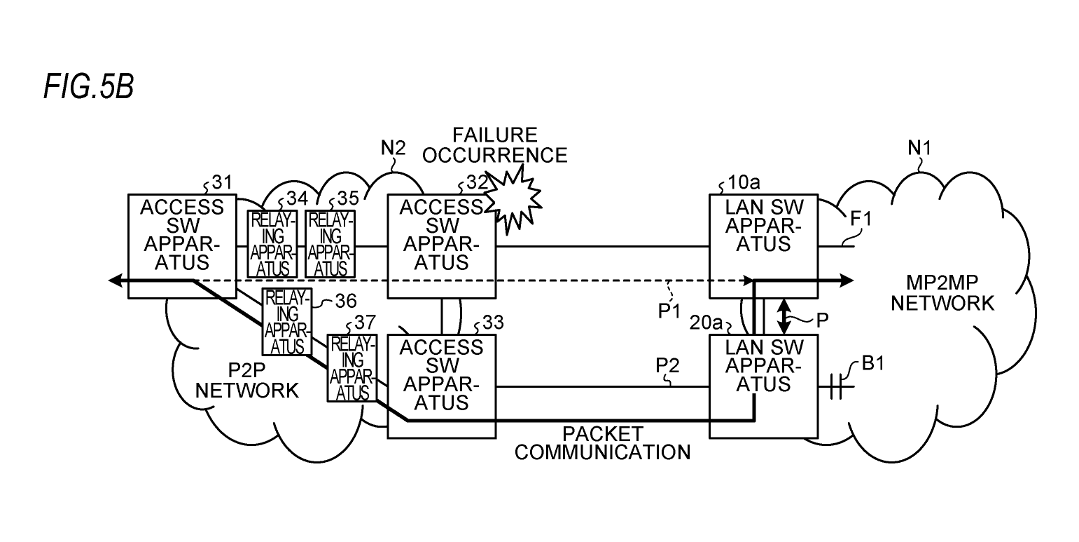

FIG. 5A is a view illustrating an example of connection between networks providing different types of services when a failure occurs in the LANSW apparatus 10a. As illustrated in FIG. 5A, when a failure occurs in the LANSW apparatus 10a of an MP2MP network N1 side, a path for frame transmission is switched from the previous active path P1 to the standby path P2. Further, a forwarding port F1 is switched to a blocking port B2 by the STP equipped in the LANSW apparatus 10a. Similarly, a blocking port B1 is switched to a forwarding port F2 by the STP equipped in an LANSW apparatus 20a.

FIG. 5B is a view illustrating an example of connection between networks providing different types of service when a failure occurs in an access SW apparatus 32. As illustrated in FIG. 5B, even when a failure occurs in the access SW apparatus 32 of the P2P network N2 side, a path for frame transmission is switched from the previous active path P1 to the standby path P2. However, since the failure that has occurred is not a failure occurring in the LAN side, switching between ports by the STP is not performed and the communication between the MP2MP network N1 and the P2P network N2 is maintained.

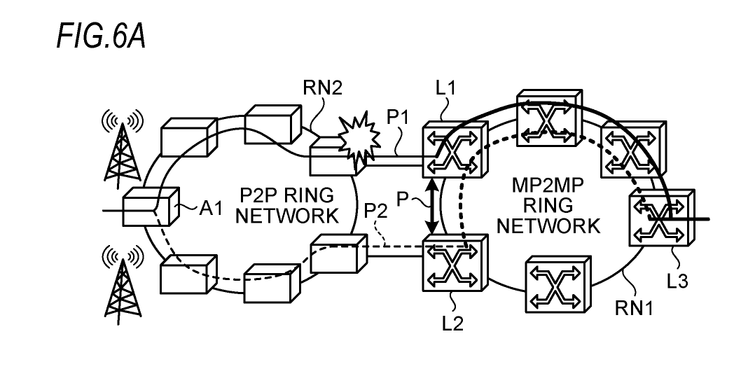

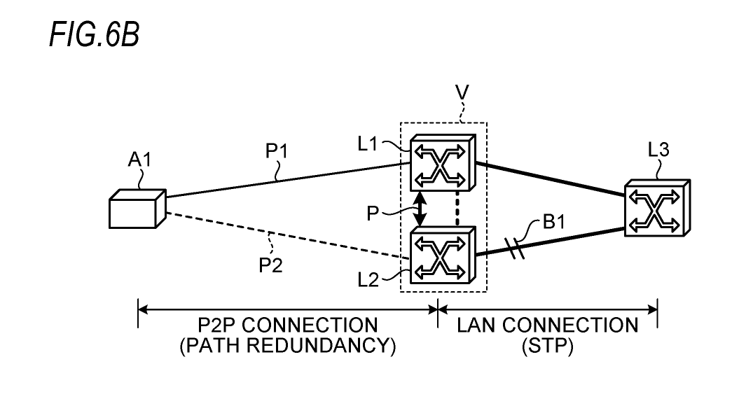

Descriptions will be made on a summary of the apparatus redundancy technology according to the present embodiment with reference to FIG. 6A and FIG. 6B. FIG. 6A is a view illustrating a physical configuration of a network to which the apparatus redundancy technology according to the present embodiment is applied. As illustrated in FIG. 6A, each of the LANSW apparatuses L1 and L2 disposed on the MP2MP ring network RN1 terminate one end of each of redundant paths P1 and P2 using different apparatuses. Accordingly, the path redundancy is constructed between the access SW apparatus A1 disposed on the P2P ring network RN2 and the LANSW apparatus L1, and between the access SW apparatus A1 and the LANSW apparatus L2. Further, each of the LANSW apparatuses L1 and L2 also constructs the path redundancy with an access SW apparatus other than the access SW apparatus A1. Therefore, in a case where an apparatus failure occurs within the P2P ring network RN2, the communication between the networks is maintained by the path redundancy, differently from the original configuration, even when the apparatus failure occurs in the interconnection point of the ring networks RN1 and RN2.

FIG. 6B is a view illustrating a logical configuration of the network to which the apparatus redundancy technology according to the present embodiment is applied. As illustrated in FIG. 6B, since the apparatus redundancy connection is made between a plurality of networks providing different types of services, the LANSW apparatuses L1 and L2 monitor the redundant paths P1, P2 between the LANSW apparatuses L1 and L2 and the access SW apparatus A1 through transmission and reception of the path management frame P, and the LANSW apparatuses L1 and L2 share the monitored result. Accordingly, since a plurality of LANSW apparatuses L1 and L2 are virtually appeared as a single communication apparatus V to the access SW apparatus A1, the fact that one ends of the redundant paths P1 and P2 are terminated by different apparatuses, respectively, is not recognized by the access SW apparatus A1.

Further, in FIG. 6B, the path management frame P which is a control signal of the apparatus redundancy is transmitted and received over a shortest route on the MP2MP ring network RN1, but may be transmitted and received via the LANSW apparatus L3. Each of the LANSW apparatuses L1 and L2 may transmit and receive the path management frame P in both directions of the MP2MP ring network RN1, so that the path management frame P may be exchanged between the redundant counterpart apparatuses even when a single failure occurs on the ring network RN.

Further, since the STP may be continuously used in the MP2MP ring network RN1, a new additional technology is not needed for an LANSW apparatus other than the LANSW apparatuses L1 and L2. Since the path redundancy technology according to G.8031 may also be continuously used in the P2P ring network RN2 side, a new technology is not needed for a lower-priced access SW apparatus compared to the LANSW apparatus. Therefore, the ring networks RN1 and RN2 may realize the apparatus redundancy connection with a simple configuration change and low price.

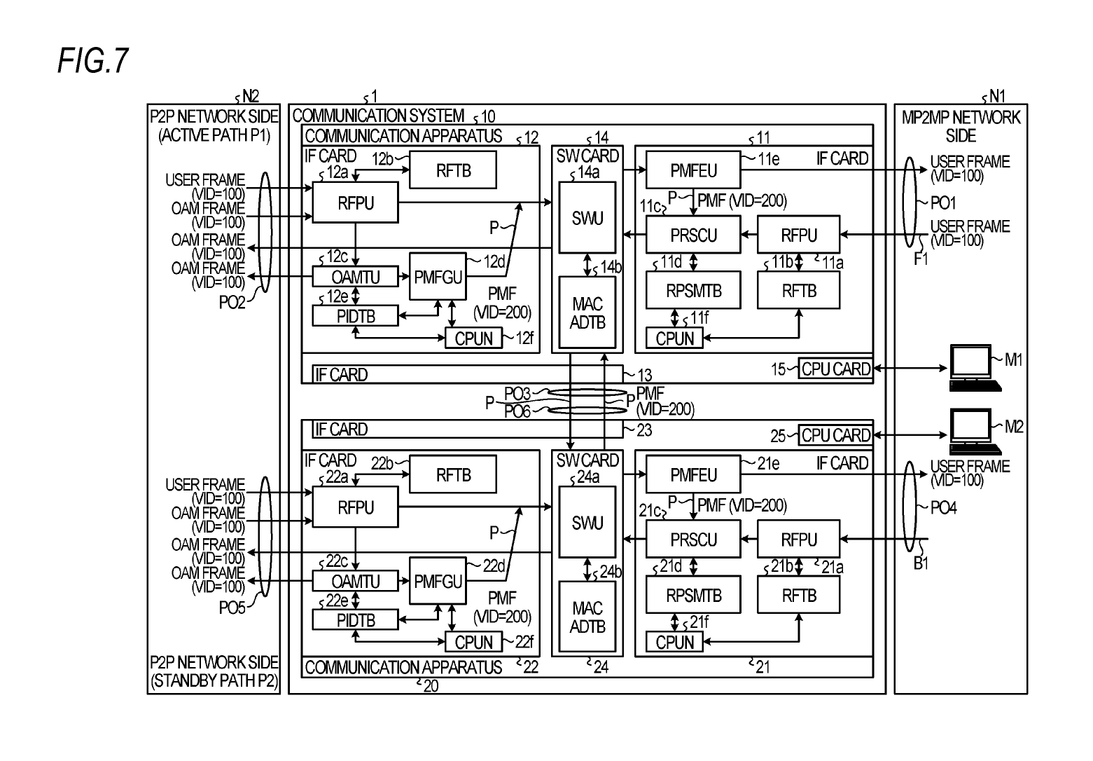

FIG. 7 is a view illustrating an exemplary configuration of a communication system 1. As illustrated in FIG. 7, the communication system 1 includes a communication apparatus 10 and a communication apparatus 20, and the path management frame P, which is represented as the shortened form “PMF”, is exchanged between the communication apparatuses 10 and 20. The communication apparatus 10 corresponds to each of the LANSW apparatuses 10a of FIG. 4, FIG. 5A and FIG. 5B and each of the LANSW apparatuses L1 of FIG. 6A and FIG. 6B. The communication apparatus 10 includes an IF (InterFace) card 11, an IF card 12, an IF card 13, a SW card 14 and a CPU (Central Processing Unit) card 15. These respective units are connected so as to allow data or signal to be input/output in one direction or both directions.

The IF card 11 includes a reception frame processing unit 11a, a reception frame table 11b, a path redundancy switching control unit 11c, a redundant paths status management table 11d, a path management frame extraction unit 11e and a CPU unit 11f. These respective units are connected so as to allow data or signal to be input/output in one direction or both directions, and represented as the shortened forms “RFPU” 11a, “RFTB” 11b, “PRSCU” 11c, “RPSMTB” 11d, “PMFEU” 11e and “CPUN” 11f in FIG. 7, respectively.

When a frame is received from the forwarding port F1, the reception frame processing unit 11a reads-out each value within the reception frame table 11b. For example, the reception frame processing unit 11a outputs the read-out value corresponding to “VID=100” together with the received frame to the path redundancy switching control unit 11c at the next stage.

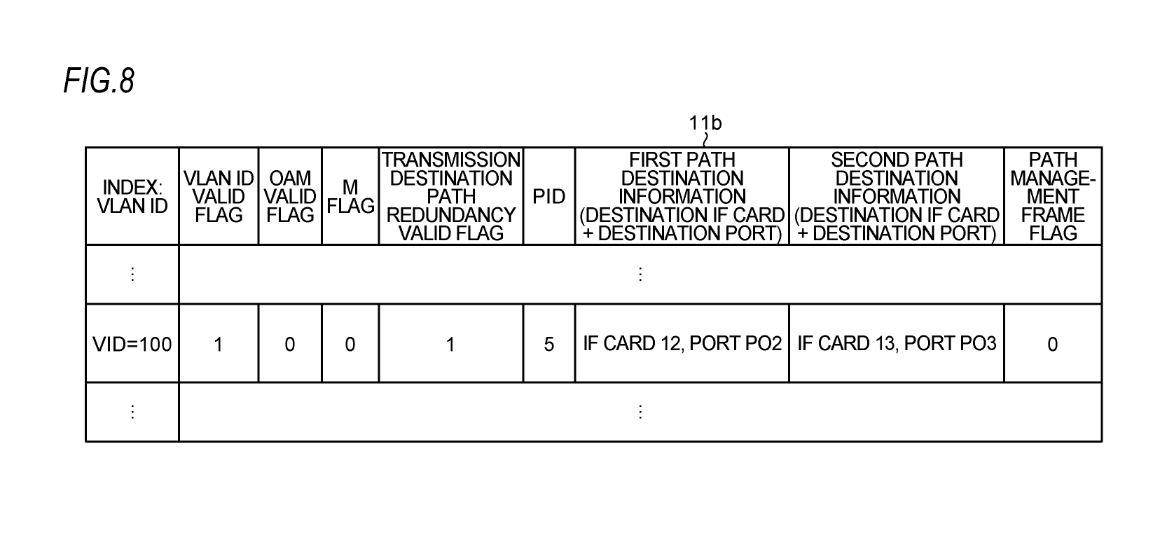

Next, descriptions will be made on the reception frame table 11b. FIG. 8 is a view illustrating an example of data stored in the reception frame table 11b of an IF card 11. As illustrated in FIG. 8, the reception frame table 11b associates a VLANID valid flag, an OAM valid flag, an M (Multicast) flag, a transmission destination path redundancy valid flag and a PID (Protection IDentification) with one another for each VLANID and stores contents of the flags and PID in each of fields for the flags and PID. Further, the reception frame table 11b associates a first path destination information, a second path destination information and a path management frame flag with one another for each VLANID, and stores the contents of the first and second path destination information and the path management frame flag in each of the fields for the path destination information and the path management flag.

The VLANID (Virtual Local Area Network IDentification, hereinafter, denoted as “VID”) is identification information for specifying a user. The VID is collectively called a VLAN tag together with TPID (Tag Protocol IDentification), and a plurality of VLANs may be stacked continuously in the VLAN tag fields.

The VLANID valid flag indicates whether a corresponding VID is valid as a received frame. When the number “1” is set in the VLANID valid flag, the corresponding VID is valid and otherwise, when the number “0” is set in the VLANID valid flag, the corresponding VID is invalid. When the corresponding VID is valid, the received frame is transmitted, but when the corresponding VID is invalid, the received frame is discarded by the reception frame processing units 11a, 12a, 21a and 22a. In FIG. 7, the reception frame processing units 12a, 21a and 22a are represented as the shortened forms “RFPU” 12a, “RFPU” 21a and “RFPU” 22a, respectively.

The OAM valid flag indicates whether an OAM frame for monitoring normality of a logical path is valid. When “1” is set in the OAM valid flag, the OAM frame is valid and otherwise, when “0” is set in the OAM valid flag, the OAM frame is invalid. When the OAM frame is valid, the reception frame processing units 12a and 22a determine an EtherType of the received frame. When it is determined that the EtherType is the OAM frame, the reception frame processing units 12a and 22a transmit the received frame to OAM termination units 12c and 22c. In FIG. 7, the OAM termination unit 12c and the OAM termination unit 22c are represented as the shortened forms “OAMTU” 12c and “OAMTU” 22c, respectively. When the OAM frame is invalid, the received frame is discarded by the reception frame processing units 12a and 22a.

The M flag is a multicast flag and when the destination of the received frame is the P2P network N2, “0” is set in the M flag and when the destination of the received frame is the MP2MP network N1, “1” is set in the M flag. When the M flag is “1”, the final destination IF card and the destination port of the received frame are determined based on the learned information stored in a MAC (Media Access Control) address table 14b of the SW card 14. In FIG. 7, the MAC address table 14b is represented as the shortened form “MACADTB” 14b. Further, when the destination is unlearned, the received frame is flooded.

The transmission destination path redundancy valid flag indicates whether the destination path of the received frame is made in the path redundancy. When “1” is set in the transmission destination path redundancy valid flag, the transmission destination path redundancy valid flag is valid (path redundancy exists) and otherwise, when “0” is set in the transmission destination path redundancy valid flag, the transmission destination path redundancy valid flag is invalid.

The PID is an intra-apparatus identifier to be set in a corresponding pair unit with respect to a pair of an active path and a standby path constituting a path redundancy. The field storing the PID is used when “1” which indicates valid is set in the transmission destination path redundancy valid flag, and when the transmission destination path redundancy valid flag is invalid, the PID is not set.

The destination IF card number and the destination port number of the received frame are set in the first path destination information and the second path destination information, respectively. First, when the destination path is the MP2MP network N1, the destination IF card and the destination port are determined by retrieving the MAC address table 14b. Therefore, it is unnecessary to set the first path destination information and the second path destination information. Next, when the destination path is the P2P network N2 and the path redundancy does not exist, the number of the destination paths is always one (1). Accordingly, the destination IF card number and the destination port number are set only in the first path destination information and does not need to be set for the second path destination information.

In the meantime, when the destination path is the P2P network N2 and the path redundancy exists, two destination paths exist. Therefore, “1” is set in the transmission destination path redundancy valid flag and the destination IF card number and the destination port number of the active path are also set in the first path destination information, and the destination IF card number and the destination port number of the standby path are set in the second path destination information. Further, determination as to whether the received frame should be transmitted to which destination path of the first path destination information and the second path destination information is not made at the time when the reception frame processing unit 11a accesses and reads the reception frame table 11b, and is made in the path redundancy switching control unit 11c at the next stage. In this case, the path redundancy switching control unit 11c refers to the redundant path status management table 11d to determine the destination path.

The path management frame flag indicates whether the received frame is a path management frame transmitted from other apparatus (e.g., communication apparatus 20). When “1” is set in the path management frame flag, the IF card 13 deletes unnecessary portion such as a MAC header which is assigned for inter-apparatus transfer from the received frame. Accordingly, the received frame becomes to have the path management frame format FF2 and is transferred via multicast as a path management frame by the SW unit 14a to other IF cards 11 and 12. In FIG. 7, the SW unit 14a is represented as the shortened form “SWU” 14a.

The path redundancy switching control unit 11c automatically generates the redundant path status management table 11d based on the path management frame P input from, for example, the path management frame extraction unit 11e. Further, the path redundancy switching control unit 11c checks the read-out value and reads-out each value within the redundant path status management table 11d based on the PID value when “1” is set in the transmission destination path redundancy valid flag. The path redundancy switching control unit 11c determines the destination of the received frame using the read-out value of the reception frame table 11b and the read-out value of the redundant path status management table 11d. Further, the path redundancy switching control unit 11c performs a path switching process between the active path P1 and the standby path P2.

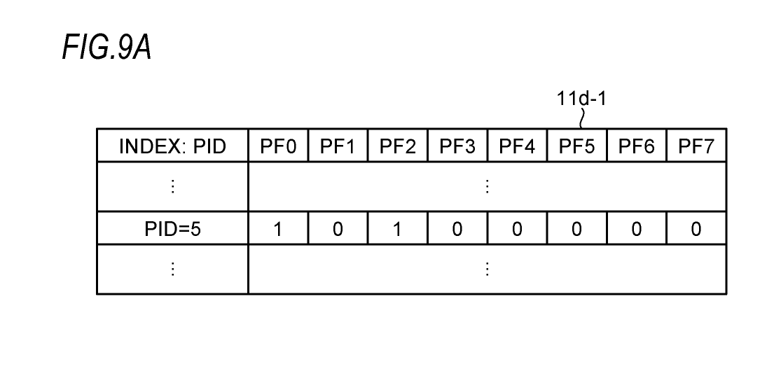

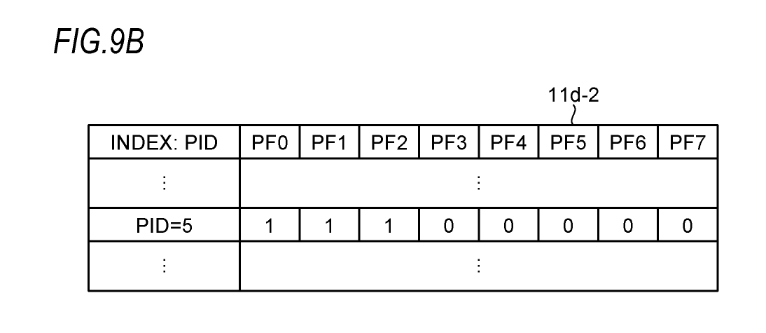

Descriptions will be made on the redundant path status management table 11d before and after a failure occurs in the active path P1 with reference to FIG. 9A and FIG. 9B. The redundant path status management table 11d is a table which stores the path information using the PID as an index. 8-bit PID information which has the same format as the PID information stored in PID tables 12e and 22e which will be described is stored in the redundant path status management table 11d as a table entry for each PID. In FIG. 7, the PID table 12e and the PID table 22e are represented as the shortened forms “PIDTB” 12e and “PIDTB” 22e, respectively. Each setting value within the redundant path status management table 11d is not set initially from software (CPU unit 11f), and details thereof will be described later. That is, each value within the redundant path status management table 11d is dynamically set by hardware according to a value of the path management frame P (values of PID tables 12e and 22e) transmitted from the IF cards 12 and 22.

FIG. 9A is a view illustrating an example of data stored in a redundant path status management table 11d before a failure occurs in the active path P1. As illustrated in FIG. 9A, each of setting values that are “PF0=1”, “PF1=0”, “PF2=1”, “PF3=0”, “PF4=0”, “PF5=0”, “PF6=0” and “PF7=0” and correspond to the “PID=5” is stored in the redundant path status management table 11d as the PID information before occurrence of the failure.

FIG. 9B is a view illustrating an example of data stored in the redundant path status management table 11d after a failure occurs in the active path P1. As illustrated in FIG. 9B, each of setting values that are “PF0=1”, “PF1=1”, “PF2=1”, “PF3=0”, “PF4=0”, “PF5=0”, “PF6=0” and “PF7=0” and correspond to the “PID=5” is stored in the redundant path status management table 11d as the PID information after occurrence of the failure. In FIG. 9B, compared to FIG. 9A, the active path status bit of field PF1 is updated from “0” which indicates a normal status to “1” which indicates a failure status.

The path management frame extraction unit 11e assigns an MAC address or a VLAN tag to any output port to install the functionality that enables the path management frame P to be transmitted to outside of the apparatus. The path management frame extraction unit 11e refers to a type from, for example, a header of the received frame and when the received frame is the path management frame P, the path management frame extraction unit 11e transfers the corresponding received frame to the path redundancy switching control unit 11c. Further, when the received frame is not the path management frame P, the path management frame extraction unit 11e transfers the corresponding received frame to outside of the apparatus via a port P01.

The CPU unit 11f integrally and comprehensively controls each component within the IF card 11.

The IF card 12 includes a reception frame processing unit 12a, a reception frame table 12b, an OAM termination unit 12c, a path management frame generation unit 12d, a PID table 12e and a CPU unit 12f. These respective units are connected so as to allow data or signal to be input/output in one direction or both directions, and represented as the shortened forms “RFTB” 12b, “PMFGU” 12d and “CPUN” 12f in FIG. 7, respectively.

The reception frame processing unit 12a receives the OAM frame for monitoring the path over which the user frame is transmitted. The reception frame processing unit 12a reads-out the reception frame table 12b using, for example, the “VID=100” as an index. Further, the reception frame processing unit 12a similarly notifies the “PID=5”, which is a table read value corresponding to the “VID=100”, together with the received OAM frame to the OAM termination unit 12c.

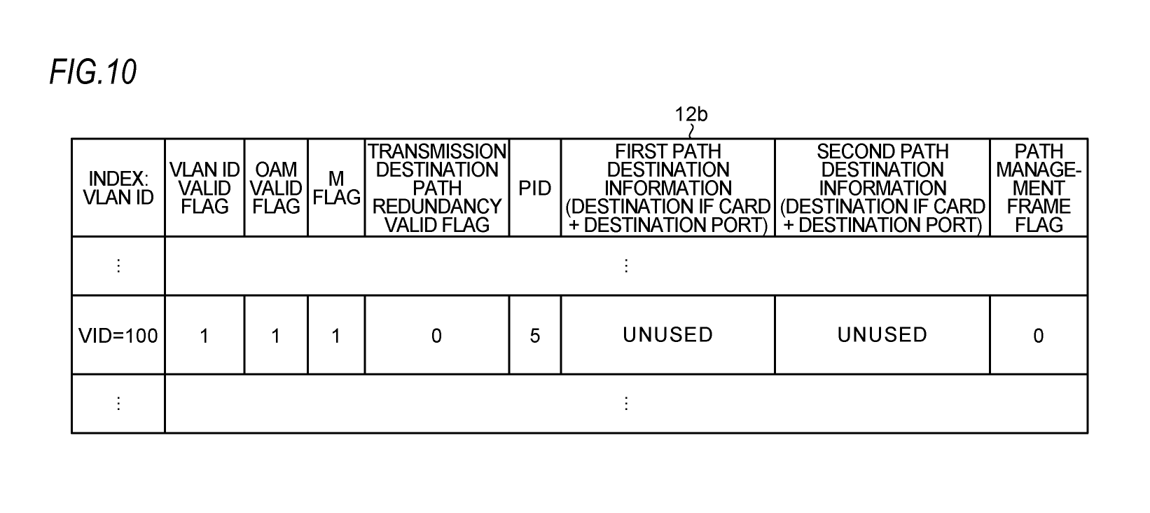

Next, descriptions will be made on the reception frame table 12b. FIG. 10 is a view illustrating an example of data stored in the reception frame table 12b of the IF card 12. As illustrated in FIG. 10, a field configuration of the reception frame table 12b and data stored therein are the same as those of the reception frame table 11b of the IF card 11 described above. Therefore, detailed descriptions thereof will be omitted.

When the OAM frame and the value of the PID are obtained from the reception frame processing unit 12a, the OAM termination unit 12c accesses the PID table 12e based on the “PID=S”. The OAM termination unit 12c updates the active path status bit PF1 of the PID table 12e according to a reception status of the OAM frame upon accessing the PID table 12e.

The path management frame generation unit 12d reads-out all the entries of the PID table 12e periodically (e.g., every 10 ms) and generates the path management frame P having a format to be described later.

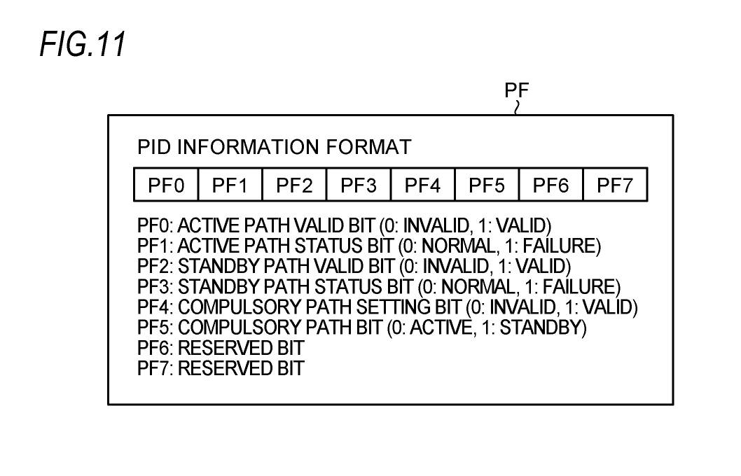

The PID table 12e stores the PID information similarly as in the redundant path status management table 11d described above. The PID information is one (1) byte information stored for each PID as information for one (1) record of the PID table 12e. FIG. 11 is a view illustrating a PID information format PF. As illustrated in FIG. 11, the PID information format PF is an information format, which is formatted in a common format in PID unit, regarding any path redundancy. The PID information format PF includes eight fields PF0 to PF7 each of which is assigned one (1) bit.

Field PF0 is an active path valid bit and stores information indicating whether the active path P1 of the P2P network N2 is valid. The number “1” indicating that the active path P1 is valid is set in the field PF0 by software (CPU unit 12f) as an initial setting value. Field PF1 is an active path status bit and stores information indicating whether a status of the active path P1 of the P2P network N2 is normal. The number “0” indicating that the active path P1 is in a normal status or the number “1” indicating that the active path P1 is in a failure status is automatically set in the field PF1 by hardware, as a monitoring result of the active path P1 by the OAM frame.

Field PF2 is a standby path valid bit and stores information indicating whether a standby path P2 of the P2P network N2 is valid. The number “1” indicating that the standby path P2 is valid is set in the field PF2 by software (CPU unit 12f) as an initial setting value. Field PF3 is a standby path status bit and stores information indicating whether a status of the standby path P2 of the P2P network N2 is in a normal status. The number “0” indicating that the standby path P2 is in a normal status or the number “1” indicating that the standby path P2 is in a failure status is automatically set in the field PF3 from hardware as a monitoring result of the standby path P2 by the OAM frame.

Field PF4 is a compulsory path setting bit and stores information indicating whether the path is to be compulsorily switched regardless of existence or non-existence of failure in the path. Field PF5 is a compulsory path bit and stores information which indicates a path (path of compulsory switching destination) to which switching is compulsorily performed when the number “1” indicating that the compulsory path setting is valid is set in the compulsory path setting bit. For example, when “1” is set in the field PF4 and “0” is set in the field PF5, the path is compulsorily switched from the standby path P2 to the active path P1. In contrast, when “1” is set in the field PF4 and “1” is set in the field PF5, the path is compulsorily switched from the active path P1 to the standby path P2.

Field PF6 and field PF7 are reserved bits. Since each of information of the compulsory path setting bit, the compulsory path bit and the reserved bits is not necessary for the apparatus redundancy connection, the PID information may be configured such that these bits are not supported and only include information of the fields PF0 to PF3. Accordingly, the communication system 1 may simply configure the PID information format PF with 4 bits.

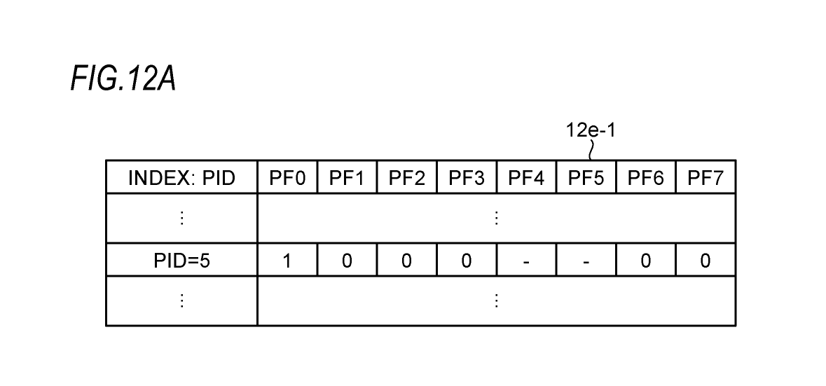

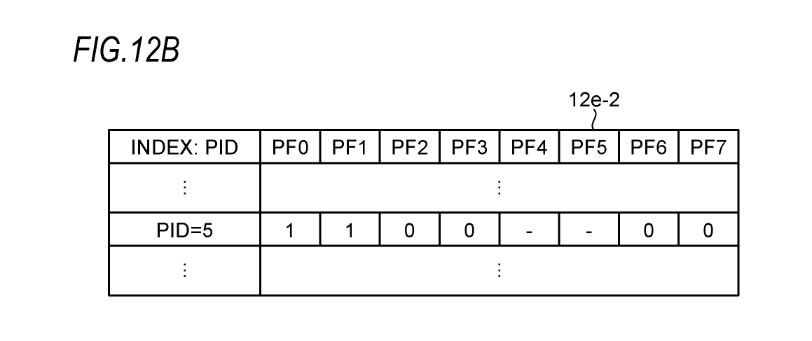

FIG. 12A is a view illustrating an example of data stored in a PID table 12e before a failure occurs in the active path P1. As illustrated in FIG. 12A, each of setting values that are “PF0=1”, “PF1=0”, “PF2=0”, “PF3=0”, “PF4=0”, “PF5=0”, “PF6=0” and “PF7=0” is stored in the PID table 12e as the PID information corresponding to the “PID=5” before occurrence of the failure. Further, the compulsory path setting bit and the compulsory path bit are not set in the PID table 12e.

FIG. 12B is a view illustrating an example of data stored in the PID table 12e after a failure occurs in the active path P1. As illustrated in FIG. 12B, each of setting values that are “PF0=1”, “PF1=1”, “PF2=0”, “PF3=0”, “PF4=0”, “PF5=0”, “PF6=0” and “PF7=0” is stored in the PID table 12e as the PID information corresponding to the “PID=5” after occurrence of the failure. In FIG. 12B, compared to FIG. 12A, the active path status bit of field PF1 is updated from “0” indicating a normal status to “1” indicating a failure status.

The CPU unit 12f integrally and comprehensively controls each component of the IF card 11 according to a predetermined software program.

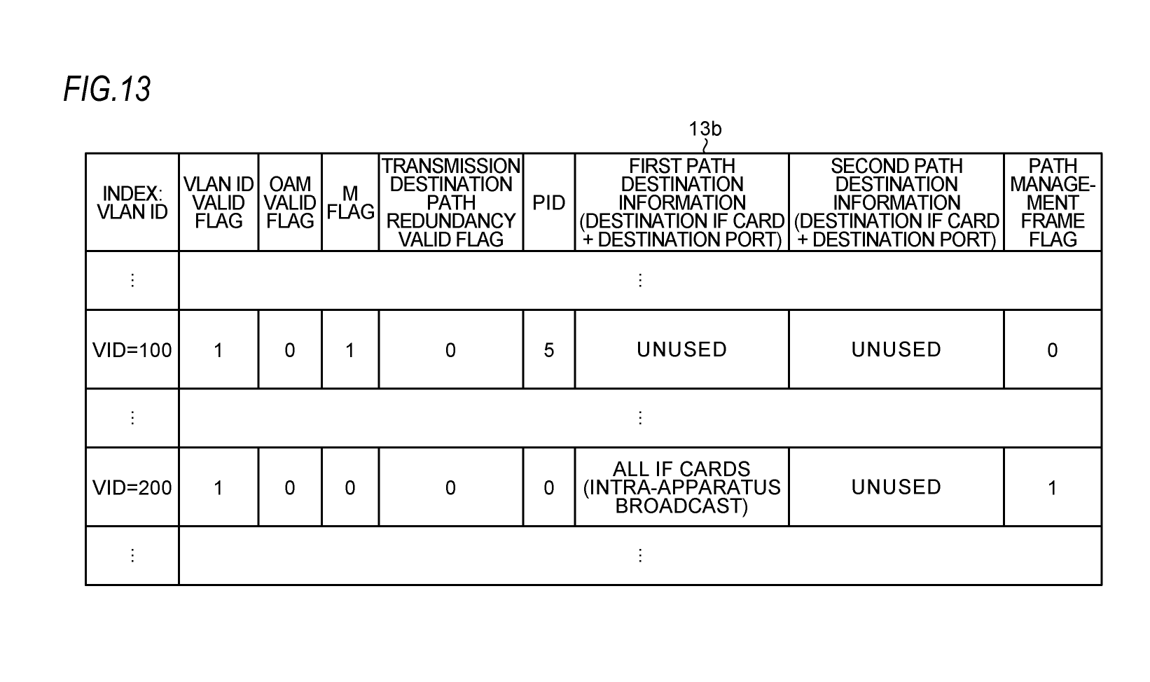

Since the IF card 13 has the same configuration as that of the IF card 11, details of the configuration will be omitted. However, the IF card 13 is different from the IF card 11 in that the IF card 13 transmits and receives the path management frame P to and from a communication apparatus 20 which is an external apparatus of the communication apparatus 10. FIG. 13 is a view illustrating an example of data stored in a reception frame table 13b of the IF card 13. As illustrated in FIG. 13, a field configuration of the reception frame table 13b and data stored therein are the same as those of the reception frame table 11b of the IF card 11 and the reception frame table 12b of the IF card 12 described above, and thus, detailed descriptions thereof will be omitted.

A SW card 14 includes a SW unit 14a and a MAC address table 14b. The SW unit 14a performs switching from the active path P1 to the standby path P2 using the monitored result for the active path P1 by its own communication apparatus 10. Further, the SW unit 14a refers to the MAC address table 14b to control the transmission or reception of the frame. Specifically, upon receiving the frame, the SW unit 14a registers a MAC SA (Source Address) of the frame received from the MP2MP network N1 and the IF card and the port number that have received the corresponding frame in the MAC address table 14b. Further, upon transmitting the frame, the SW unit 14a retrieves the MAC address table 14b based on a MAC DA (Destination Address) of the frame to be transmitted to the MP2MP network N1. When a MAC DA which is coincident with that of the frame as a result of the retrieval is present (when being unlearned), the SW unit 14a transfers the frame by setting the IF card number and the port number for which registration are completed as the destination. When the MAC DA which is coincident with that of the frame is not present (when being unlearned), the SW unit 14a performs broadcast transfer (flooding) to all the ports except for reception port of the frame to be transmitted among the ports connected to the MP2MP network N1. Further, even in this case, the frame is not transmitted to a port, for example, the blocking port B1, which is set as a blocking port by the STP.

The CPU card 15 integrally and comprehensively controls each of the CPU units of the IF cards 11, 12 and 13 according to a predetermined software program.

While the configuration of the communication apparatus 10 has been described above, the configuration of the counterpart communication apparatus 20 is the same as that of the communication apparatus 10. Therefore, the units of the communication apparatus 20 that are the same as those of the communication apparatus 10 are denoted by reference numerals having the same end portion, and detailed descriptions thereof will be omitted. Specifically, an IF card 21, IF card 22, IF card 23, SW card 24 and CPU card 25 of the communication apparatus 20 correspond to the IF card 11, IF card 12, IF card 13, SW card 14 and CPU card 15 of the communication apparatus 10, respectively. Further, the communication apparatus 20 corresponds to each of the LANSW apparatuses 20a of FIG. 4, FIG. 5A and FIG. 5B and each of the LANSW apparatuses L2 of FIG. 6A and FIG. 6B.

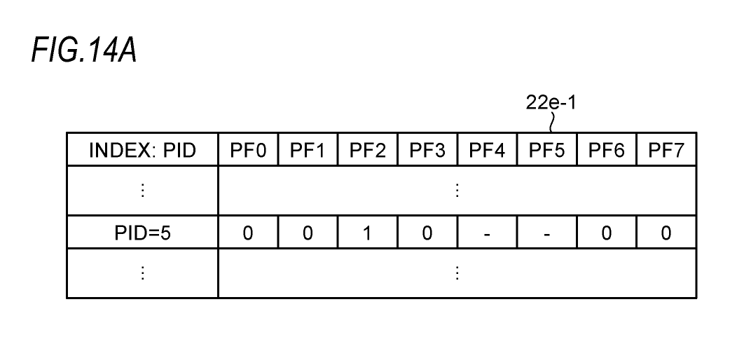

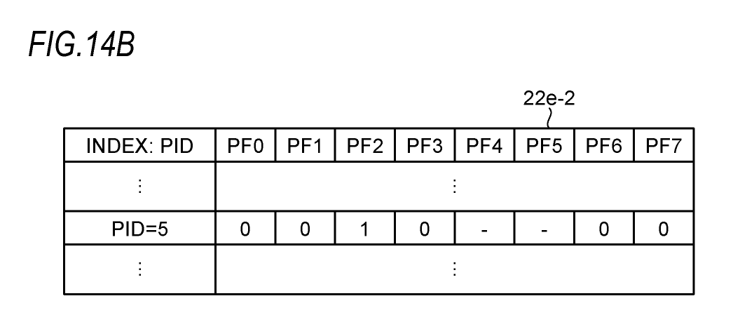

A PID table 22e is also installed to be able to be updated in the IF card 22 of the communication apparatus 20 similarly as in the IF card 12 of the communication apparatus 10. FIG. 14A is a view illustrating an example of data stored in a PID table 22e before a failure occurs in the active path P1. As illustrated in FIG. 14A, each of setting values that are “PF0=0”, “PF1=0”, “PF2=1”, “PF3=0”, “PF6=0” and “PF7=0” is stored in the PID table 12e as the PID information corresponding to the “PID=5” before occurrence of the failure. Further, the compulsory path setting bit and the compulsory path bit are not set in the PID table 12e.

FIG. 14B is a view illustrating an example of data stored in the PID table 22e after a failure occurs in the active path P1. As illustrated in FIG. 14B, each of setting values that are “PF0=0”, “PF1=0”, “PF2=1”, “PF3=0”, “PF6=0” and “PF7=0” is stored in the PID table 12e as the PID information corresponding to the “PID=S” after occurrence of the failure. In FIG. 14A and FIG. 14B, the active path status bit of the field PF0 is “0” and the active path P1 is set as invalid. Therefore, even when a failure occurs in the active path P1, a value of the active path status bit of the field PF1 is maintained as “0” as before occurrence of the failure and is not updated.

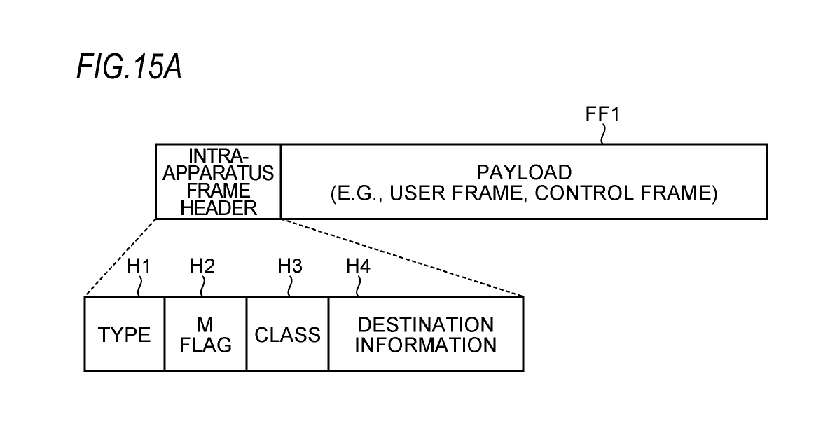

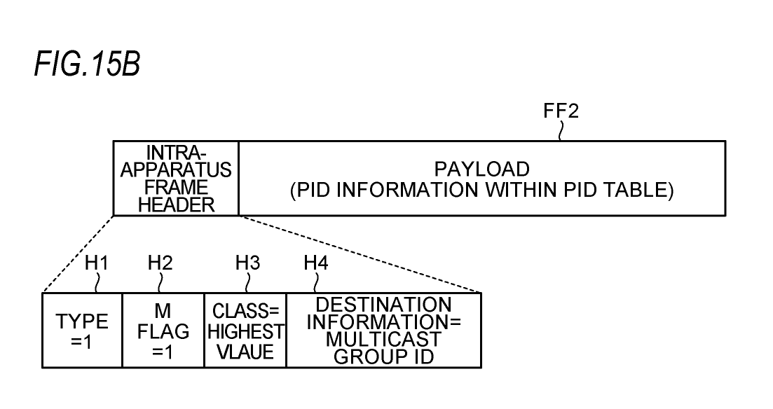

Descriptions will the made on a format of the frame which is transmitted and/or received within the communication system 1 with reference to FIG. 15A and FIG. 15B. First, intra-apparatus frame format will be described. The intra-apparatus frame format is a format transmitted and/or received between the IF cards 11 and 12 through the SW card 14 of the communication apparatus 10.

FIG. 15A is a view illustrating an intra-apparatus frame format FF1. As illustrated in FIG. 15A, the intra-apparatus frame format FF1 includes an intra-apparatus frame header and a payload. The intra-apparatus frame header includes fields of “type H1”, “M flag H2”, “class H3” and “destination information H4”. The type H1 indicates a type of frame to be transferred. For example, when a value “0” is set in the type, the frame is a user frame or a control frame other than the path management frame P and when a value “1” is set in the type, the path management frame P.

As described above, the M flag H2 is a multicast flag and a value “0” is set in the flag when the frame is transferred via unicast, and a value “1” is set in the flag when the frame is transferred via multicast. Here, the unicast transfer is a transfer method in which the destination of the received frame is a single IF card or a single port, and the multicast transfer is a transfer method in which the destination of the received frame is a plurality of IF cards or a plurality of ports. Further, among the frames transferred via multicast, the destination of the frame other than the path management frame P is determined by retrieving the MAC address table 14b within the SW card 14. Further, when the frame is transferred via multicast, copying data to the plurality of IF cards or the plurality of ports is performed by the SW unit 14a within the SW card 14.

The class H3 indicates a priority when the frame is transferred. Various levels, for example, 8 levels of classes are set in the class H3 and when intra-apparatus congestion of frames occurs in, for example, the SW card 14, a frame having a higher class is preferentially transmitted. The priority value set to the VLAN tag described above may be used for allocating a class to the received frame, but a value for allocating a class to the received frame may be converted from the corresponding priority value to any class value if necessary. But, in the latter case, the communication apparatus 10 separately installs a class conversion table in the SW card 14. Accordingly, the communication apparatus 10 may perform a control by which a top class within its own apparatus is allocated only to the path management frame P without using a top class for the user frame or the control frame.

Further, when a target frame to which a class is to be allocated is a frame without a tag, the communication apparatus 10 may install a class information field in each of the reception frame tables 11b, 12b and 13b of the IF cards 11, 12 and 13 so as to be able to cope with a transfer control according to the class.

The destination information H4 indicates a destination of frame. When transferring via unicast (when M flag is 0 (zero)), the IF card number and the port number which become the destination are set in the destination information H4. In contrast, upon transferring via multicast (when M flag is 1 (one)), a multicast group ID is set in the destination information H4. The multicast group ID is information for identifying a combination of a plurality of IF cards or ports which become the destination of frame. The SW card 14 of the communication apparatus 10 obtains a plurality of the destination information which become the multicast transfer destinations based on the multicast group ID and copies the target frame to be transferred. The SW card 14 resets the obtained destination information, that is, each of the destination IF card number and the destination port number in intra-apparatus frame header, and transfers the frame to the destination IF card as the intra-apparatus frame.

Further, the user frame and the control frame are stored in the payload of the intra-apparatus frame format FF1.

Descriptions will be made on the path management frame format. FIG. 15B is a view illustrating a path management frame format FF2. As illustrated in FIG. 15B, the path management frame format FF2 includes an intra-apparatus frame header and a payload. The path management frame format FF2 has a header having a format which is the same as that of the intra-apparatus frame format FF1, but the value of the header is fixedly set differently from the intra-apparatus frame format FF1. That is, each of values of “type H1=1”, “M flag H2=1”, “class H3=highest value”, “destination information H4=multicast group ID” is set in the header of the path management frame format FF2 at all times.

The PID information (see, FIG. 11) within the PID table 12e (see, FIG. 12A and FIG. 12B) of the IF card 12 is set in the payload of the path management frame format FF2. The path management frame P having the path management frame format FF2 is also transmitted and/or received between the apparatuses differently from the intra-apparatus frame described above, but the PID information is optimized (minimized) as one byte (8-bit) format. Therefore the quantity of communication data between the communication apparatuses 10 and 20 is suppressed.

The path management frame P contains the PID information of all the redundant paths accommodated in the communication apparatus 10 in the payload. Therefore, when the communication apparatus 10 accommodates, for example, 8192 redundant paths, the PID information for 8192 redundant paths are used as a common identifier within the communication system 1. In this case, a data capacity of at least 8192×1 bytes is needed for the PID table 12e. As described above, since the path management frame P aggregates data within the PID table 12e into a frame, when the length of the intra-apparatus frame header is set to 4 bytes, the frame length of the path management frame P is 8196 bytes (resulted from addition of 4 bytes and 8192 bytes).

Further, the path management frame P is generated and transferred at a regular time interval of 10 ms using the read-out value of the PID table 12e updated at every 3.3 ms. Therefore, the transfer rate of the path management frame P is about 6.6 Mbps calculated from 8196 bytes×8 bits×100 frames per second, that is, 6,556,800 bits per second. In the meantime, the transfer rate of the intra-apparatus data bus of the large-capacity communication apparatus disposed at the core network side such as the MP2MP network N1 is, for example, 100 Gbps. Therefore, when the transfer rate is about 6.6 Mbps, the communication system 1 may suppress an effect given to other communication by the inter-apparatus communication of the path management frame P to be minimized.

Next, the operations of the communication system 1 will be described.

First, a PID table update processing, a path management frame generation processing and a redundant path status management table update processing will be described with reference to FIG. 7.

The IF card 12 of the communication apparatus 10 receives an OAM frame for monitoring the path over which the user frame is transmitted by the reception frame processing unit 12a. In the present embodiment, since the “VID=100” is allocated to the frame, the reception frame processing unit 12a reads-out the reception frame table 12b using the “VID=100” as an index. Referring back to FIG. 10, the number “1” indicating a valid is set in the OAM valid flag which is in association with the “VID=100”. Therefore, the reception frame processing unit 12a similarly notifies the “PID=5” which is a table read value being associated with the “VID=100” together with the received OAM frame to the OAM termination unit 12c.

When the OAM frame and the PID value are obtained from the reception frame processing unit 12a, the OAM termination unit 12c accesses the PID table 12e based on the “PID=5”. The OAM termination unit 12c updates the active path status bit PF1 according to the reception status of the OAM frame upon accessing the PID table 12e. When the OAM frame has been received at a predetermined time interval (e.g., 3.3 ms), the number “0” indicating that the active path P1 is in a normal status is set in the PF1 field of the “PID=S” within the PID table 12e (see, for example, FIG. 12A). In contrast, when the OAM frame of the “VID=100” has not been received for a predetermined period of time, the value “0” in the PF1 field of the “PID=5” is updated with the value “1” indicating that the active path P1 is in a failure status. Further, in ITU-T G.8031 standard, when the OAM frame transmitted at the time interval of 3.3 ms has not been received three times continuously, it is determined that a failure has occurred in the communication system 1. Therefore, the predetermined period of time is about 10 ms (calculated from 3.3 ms×3 times).

The same processing as those of described above is performed with respect to the standby path P2 in the IF card 22 of the communication apparatus 20.

The path management frame generation unit 12d of the IF card 12 reads-out all the entries of the PID table 12e periodically (e.g., every 10 ms) and generates the path management frame P having the format illustrated in FIG. 15B. Data within the PID table 12e which is always updated to be in the newest status is stored in the path management frame P. The path management frame P is transferred to other IF cards 11 and 13 via the SW unit 14a of the SW card 14. The processing described above are performed by hardware without software processing by the CPU unit 12f of the IF card 12.

Further, the path management frame P is periodically generated from an IF card (e.g., IF cards 12 and 22) connected to the redundant paths (e.g., a pair of active path P1 and standby path P2) regardless of the type of path. That is, the path management frame P is also similarly generated by the path management frame generation unit 22d periodically in the IF card 22 of the communication apparatus 20. In FIG. 7, the path management frame generation unit 22d is represented as the shortened form “PMFGU” 22d.

Further, when a failure occurs at one LANSW apparatus, the path management frame P which has been received periodically up until now is not received in the other LANSW apparatus. In this case, the other LANSW apparatus determines that a failure has occurred and performs switching of the path. As described above, in the communication system 1, the path management frame P is periodically transmitted through the apparatus redundancy connection, so that communications may be continued even when the failure occurs at one of the LANSW apparatuses.

In the present embodiment, the path management frame P is transmitted to a counterpart communication apparatus of the pair which forms the apparatus redundancy. That is, the path management frame extraction units 11e and 21e assign any MAC address or VLAN tag to any output port so as to install functionality that enables transmitting the path management frame P to outside of the apparatus. In FIG. 7, the path management frame extraction units 21e is represented as the shortened form of “PMFEU” 21e. The IF cards 13 and 23 transmit, for example, the path management frame P to which an MAC header of the “VID=200” is assigned from the ports P03 and P06, respectively.

The IF cards 13 and 23 receive the “VID=200” from the IF cards 23 and 13 of the counterpart apparatus of apparatus redundancy, respectively. Referring back to FIG. 13, since “1” is set in the VLANID valid flag in the frame of “VID=200”, each of the IF cards 13 and 23 receives a corresponding frame as a valid frame. Further, “1” is set in the path management frame flag in the frame of “VID=200”. Therefore, each of the IF cards 13 and 23 deletes the MAC header of the frame received from the IF cards 23 and 13 of the counterpart apparatus of apparatus redundancy and transmits the received frame to the SW cards 14 and 24 in the format of the path management frame format FF2 illustrated in FIG. 15B. Accordingly, each of the communication apparatuses 10 and 20 completes obtaining of the path management frame P of each of the counterpart apparatuses 20 and 10 of the apparatus redundancy connection.

Then, the path management frame P is transferred to the other IF cards within the communication apparatus 10 via multicast by the SW unit 14a. Similarly, the path management frame P is transferred to the other IF cards within the communication apparatus 20 via multicast by the SW unit 24a. In FIG. 7, the SW unit 24a is represented as the shortened form of “SWU” 24a. Accordingly, the IF cards 11 and 21 receive the path management frame P.

Subsequently, operations of the IF card 11 will be described. In the IF card 11, all the frames received from the SW card 14 are obtained first by the path management frame extraction unit 11e. The path management frame extraction unit 11e refers to a type from the header of the received frame. When the received frame is the path management frame P, the path management frame extraction unit 11e transfers the corresponding frame to the path redundancy switching control unit 11c. In the meantime, when the received frame is not the path management frame P, the path management frame extraction unit 11e transfers the corresponding received frame to the outside of the apparatus via a port P01.

The path redundancy switching control unit 11c automatically generates the redundant path status management table 11d (see, for example, FIGS. 9A and 9B) based on the path management frame P input from the path management frame extraction unit 11e. The redundant path status management table 11d is updated with the corresponding frame each time when the path redundancy switching control unit 11c obtains a new path management frame P. Further, the path management frame P is discarded by the path redundancy switching control unit 11c after the redundant path status management table 11d is generated and updated.

The update processing of the redundant path status management table 11d is performed as follows. The path redundancy switching control unit 11c checks the active path valid bit of PF0 field and the standby path valid bit of PF2 field among the PID information of each redundant paths (see FIG. 11) stored in the payload of the path management frame P input from the path management frame extraction unit 11e. When “1” is set in at least one of the active and standby path valid bits, the path redundancy switching control unit 11c determines that the information of a path status bit in which “1” is set among the PID information of the corresponding PID (e.g., “PID=5”) is valid information. Also, the path redundancy switching control unit 11c overwrites values of the path valid bit and the path status bit being associated with the PID within the redundant path status management table 11d with the input PID information to be updated. Accordingly, the newest redundant paths information are aggregated in the PID unit and maintained in the redundant path status management table 11d at all times.

Referring back to FIG. 9A and FIG. 9B, when, for example, the “PID=5”, “1” is set in both the active path valid bit of PF0 field and the standby path valid bit of PF2 field among the PID information. Accordingly, the path redundancy switching control unit 11c determines that each of values of the active path status bit and the standby path status bit among the PID information associated with the “PID=5” is a valid value. Therefore, the path redundancy switching control unit 11c updates the values of the active and the standby path valid bits PF0 and PF2 and values of the active and the standby path status bits PF1 and PF3, which are associated with the “PID=5” within the redundant path status management table 11d, with those values notified by the new path management frame P, respectively.

Further, also in the IF card 21, the redundant path status management table 21d is similarly updated based on the path management frame P received from the communication apparatus 10 side.

According to the operations described above, even when multiple redundant paths exist within the communication system 1, current statuses of the active path P1 and the standby path P2 are notified to each of the IF cards 11 and 21 via the path management frame P. Accordingly, each of the redundant path status management tables 11d and 21d is automatically updated. Therefore, each of the IF cards 11 and 21 of the communication apparatus 10 and 20 may grasp the newest status of the redundant paths at a predetermined time interval (e.g., 10 ms). In other words, the newest status of the path may be shared between the communication apparatuses 10 and 20.

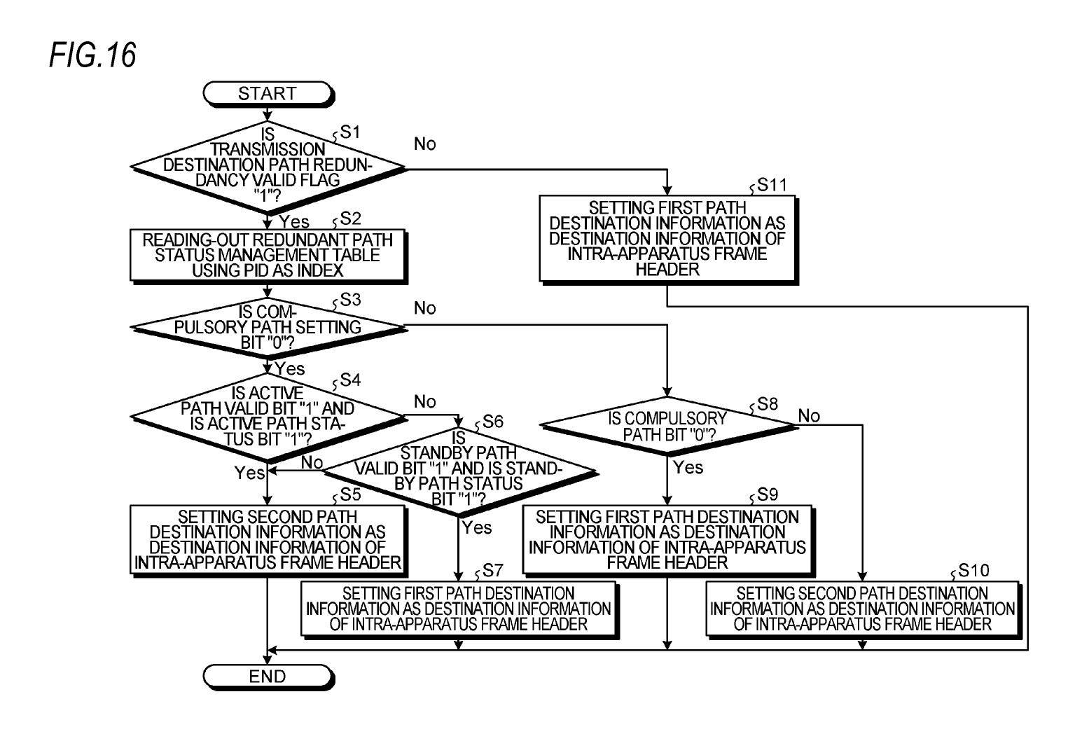

The path switching process will be described with reference to FIG. 16.

When a frame is received from a forwarding port F1, the IF card 11 reads-out each value within the reception frame table 11b (see, for example, FIG. 8) by the reception frame processing unit 11a. In the present embodiment, since the VID value of the received user frame is “100”, the reception frame processing unit 11a outputs the read-out value associated with the “VID=100” together with the received frame to the path redundancy switching control unit 11c at next stage.

The path redundancy switching control unit 11c checks the read-out value, and reads-out each value of the redundant path status management table 11d based on the PID value (“5” in the present embodiment) when “1” is set in the transmission destination path redundancy valid flag. Accordingly, the path redundancy switching control unit 11c obtains the newest information of the redundant paths associated with the “PID=5” from the redundant path status management table 11d in which the newest status is reflected.

The path redundancy switching control unit 11c determines a destination of the received frame using the read-out value of the reception frame table 11b and the read-out value of the redundant path status management table 11d. FIG. 16 is a view illustrating a flowchart for explaining a frame destination determination process executed by a path redundancy switching control unit 11c of the IF card 11 of the communication apparatus 10.

Firstly, at step S1, the path redundancy switching control unit 11c determines whether the transmission destination path redundancy valid flag associated with of the VID of the received frame is “1”. When it is determined that the transmission destination path redundancy valid flag is “1” (“YES” at step S1), the path redundancy switching control unit 11c reads-out the redundant path status management table 11d using the value of the PID associated with the VID of the received frame as an index (step S2).

After reading out the redundant path status management table, the path redundancy switching control unit 11c determines whether a value of a compulsory path setting bit of PF4 field associated with the PID is “0” (step S3). When it is determined that the compulsory path setting bit is “0” (“YES” at step S3), the path redundancy switching control unit 11c further determines whether a value of an active path valid bit of the PF0 field associated with the PID is “1” and a value of an active path valid bit of the PF1 field is “1” (step S4).

When it is determined that the PID information of the received frame satisfies all the conditions described above (“YES” at step S4), the path redundancy switching control unit 11c determines that a failure occurs in the active path P1 and detours the received frame to the standby path P2 side. That is, the path redundancy switching control unit 11c sets the second path destination information (see, for example, FIG. 8) associated with the “VID=100” within the reception frame table 11b as the destination information H4 (see, for example, FIG. 15A) of the intra-apparatus frame header of the received frame (step S5). Referring to FIG. 8, in the present embodiment, the “IF card 13” and the “port PO3” are stored as the second path destination information (see, for example, FIG. 8) associated with the “VID=100”. Accordingly, the frame received from the MP2MP network N1 side is transferred to the communication apparatus 20 through the port P03 included in the IF card 13 and then sent out to the standby path P2 by the SW unit 24a of the SW card 24.

In the meantime, when it is determined at step S4 that the PID information of the received frame does not satisfy at least one of the conditions described above (“NO” at step S4), the path redundancy switching control unit 11c performs the following determination processing. That is, the path redundancy switching control unit 11c determines whether a value of a standby path valid bit of PF2 field associated with the PID is “1” and a value of a standby path valid bit of PF3 field associated with the PID is “1” (step S6).

When it is determined that the PID information of the received frame satisfies all the conditions described above (“YES” at step S6), the path redundancy switching control unit 11c determines that a failure occurs in the standby path P2 and passes through the received frame to the active path P1 side. That is, the path redundancy switching control unit 11c sets the first path destination information (see, for example, FIG. 8) associated with the “VID=100” within the reception frame table 11b as the destination information H4 (see, for example, FIG. 15A) of the intra-apparatus frame header of the received frame (step S7). Referring again to FIG. 8, in the present embodiment, the “IF card 12” and the “port PO2” are stored as the first path destination information (see, for example, FIG. 8) associated with the “VID=100”. Accordingly, the received frame from the MP2MP network N1 side is sent out to the standby path P1 through the port PO2 included in the IF card 12 by the SW unit 14a of the SW card 14.

In the meantime, when it is determined at step S6 that the PID information of the received frame does not satisfy at least one of the conditions described above (“NO” at step S6), the path redundancy switching control unit 11c performs the processing of step S5 described above and ends the path switching process.

When it is determined at step S3 that the compulsory path setting bit is “1” (“NO” at step S3), the path redundancy switching control unit 11c determines that the compulsory path setting is valid and further, determines whether a value of the compulsory path bit of the PF5 field associated with the PID is “0” (step S8). When it is determined that the value of compulsory path bit is “0” (“YES” at step S8), the path redundancy switching control unit 11c performs the same processing as that of step S7 described above (step S9), and ends the path switching process. Accordingly, a compulsory path switching to the active path P1 is completed regardless of the existence or non-existence of a failure of the path.

In contrast, when it is determined that the value of compulsory path bit is “1” (“NO” at step S8), the path redundancy switching control unit 11c performs the same processing as that of step S5 described above (step S10), and ends the path switching process. Accordingly, a compulsory path switching to the active path P1 is completed regardless of the existence or non-existence of a failure in the path.

Further, when it is determined at step S1 that the transmission destination path redundancy valid flag associated with the “VID=100” of the reception frame is “0” (“NO” at S1), the path redundancy switching control unit 11c performs the same processing as that of step S7 described above (step S11), and ends the path switching process.

As described above, the received frame of the IF card 11 is transferred to a predetermined destination via the SW card 14 according to the destination IF card number and the port number obtained by the frame destination determination processing described above.

Up until now, the path switching process in the IF card 11 of the communication apparatus 10 has been described. However, when the blocking port B1 of the communication apparatus 20 side is a forwarding port, the path switching process is similarly performed on the received frame by referring to and using the redundant path status management table 21d, in the path redundancy switching control unit 21c of the IF card 21. In FIG. 7, the path redundancy switching control unit 21c is represented as the shortened form “PRSCU” 21c.

As described above, the communication system 1 according to the present embodiment includes the communication apparatus 10 and the communication apparatus 20. The communication apparatus 10 connects the active path P1 of the P2P network N2 with the MP2MP network N1. The communication apparatus 20 connects the standby path P2 of the P2P network N2 with the MP2MP network N1. The communication apparatus 10 notifies the status of the active path P1 to the communication apparatus 20. The communication apparatus 20 transfers data which is transferred from the standby path P2 to the MP2MP network N1 based on the notified status of the active path P1. For example, the communication apparatus 10 notifies the status of the active path P1 to the communication apparatus 20 at a predetermined time interval, and when the status of the active path P1 is not received at the predetermined time interval, the communication apparatus 20 transfers data transferred from the standby path P2 to the MP2MP network N1.

Specifically, the communication system 1 includes the communication apparatus 10 and the communication apparatus 20 in the MP2MP network N1. The communication apparatus 10 includes the OAM termination unit 12c and the SW unit 14a. The communication apparatus 20 includes the OAM termination unit 22c and the SW unit 24a. The OAM termination unit 12c monitors the status of the active path P1 which connects the communication apparatus 10 and the P2P network N2. The SW unit 14a transmits the monitored result by the OAM termination unit 12c to the communication apparatus 20. In the meantime, the OAM termination unit 22c connects the communication apparatus 20 and the P2P network N2, and monitors the status of the standby path P2 which may be switched to and from the active path P1. The SW unit 24a receives the monitored result transmitted from the SW unit 14a and determines whether switching between the standby path P2 and the active path P1 is to be made using the corresponding transmitted monitored result and the monitored result by the OAM termination unit 22c.

That is, the communication system 1 defines the PID as a common identifier between the redundant apparatuses for managing the path redundancy set in the P2P network N2 side and, loads the information of the corresponding PID on the path management frame P to transmit the loaded information to a frame generation source and the redundant counterpart apparatus. Accordingly, the newest status of redundant paths is shared between the redundant apparatuses. Therefore, the communication system 1 may virtually determine a plurality of redundant apparatuses as a single apparatus to manage and control the redundant apparatuses. Therefore, while a redundancy configuration in which both the active path and the standby path are terminated at a single apparatus has been adopted in the conventional communication system, the active path and the standby path are terminated at different apparatuses in the communication system 1 according to the present disclosure, respectively. That is, even when each of the active path and the standby path is terminated at different apparatuses also in the P2P network N2, a path redundancy configuration may be implemented and thus, the path redundancy configuration and the apparatus redundancy configuration may be used jointly. In the meantime, since the MP2MP network N1 is a network which may be terminated by multiple apparatuses, both networks may be terminated. Therefore, the communication system 1 may connect both networks. Accordingly, the apparatus redundancy connection between networks providing different types of services may be implemented. As a result, the fault tolerance for a case where a plurality of network, (e.g., the MP2MP network N1 and P2P network N2) providing different types of services are connected with one another as well as the reliability of the network accommodating the communication system 1 are improved.

Further, in the communication system 1, the communication apparatus 10 may also be adapted to include the path management frame generation unit 12d which generates the path management frame P indicating the status of the active path P1 using the monitored result. In the meantime, the communication apparatus 20 may also be adapted to include the path management frame generation unit 22d which generates the path management frame P indicating the status of the active path P2 using the monitored result. Further, the SW unit 24a of the communication apparatus 20 transmits the path management frame P generated by the path management frame generation unit 22d to the communication apparatus 10. The SW unit 14a of the communication apparatus 10 receives (obtains) the path management frame P transmitted (provided) by the SW unit 24a. Further, the path redundancy switching control unit 11c determines one of the active path P1 and the standby path P2 as a path to be used for transmitting (e.g., transferring) the frame based on the path management frame P indicating the status of the active path P1 and the path management frame P indicating the status of the standby path P2. The SW unit 14a of the SW card 14 transmits the frame to the path determined by the path redundancy switching control unit 11c.

That is, the communication system 1 allocates the PID which is an intra-apparatus identifier adapted to be managed by hardware in pair unit of the active path P1 and the standby path P2 which form the path redundancy. Further, the communication system 1 autonomously generates the PID tables 12e and 22e which manage the status of the corresponding redundant paths in the PID unit. Further, in the communication system 1, the path management frame P including information within the corresponding table is periodically generated and transmitted and/or received between the IF cards within the redundant apparatuses 10 and 20, so that a plurality of hardware are associated with one another so as to share the newest path status. That is, upon switching the path, the communication system 1 performs an autonomous path switching processing without software processing by the CPU. Therefore, even when the number of paths accommodated in an entire network increases, a processing load of the CPU (e.g., CPU unit 11f, CPU unit 12f and CPU card 15) does not increase. Therefore, a fast and stable path switching may be performed between the communication apparatuses 10 and 20 for which redundant connection is made.

Further, the communication system 1 allocates a highest priority class to the path management frame P and performs an intra-apparatus multicast transfer so as to implement an efficient path switching. Since only the minimum path information (PID information) having a common format between different hardware is included in the path management frame P, the communication system 1 may generate the path management frame P using a small data capacity. Therefore, even when an inter-apparatus exchange of the path management frame P is performed at a short time interval, the communication system 1 may suppress an influence on the network (e.g., MP2MP network N1) side to be small. In other words, since information included in the path management frame P is specialized with the minimum information that is useful for switching control of the path redundancy, even when the path management frame P is transferred inside and outside of the apparatus, the communication system 1 does not give a large load on a data path within the apparatus or the network. Therefore, a high speed communication is maintained even in the network (e.g., Ethernet (registered trademark)) in which connection between networks providing different types of services made through the apparatus redundancy connection.

More specifically, when a failure occurs in the P2P network N2 side, a path may be switched within a period of time of 50 ms by the apparatus redundancy technology according to the present embodiment. However, in the transfer of the path management frame P between the apparatuses, the transfer delay occurs depending on the number of relaying nodes or transfer distance between the communication apparatuses 10 and 20. For example, when the communication system 1 periodically transfers the path management frame P at every 10 ms as in the present embodiment, a network designer is required to design a network such that the transfer delay occurring between the apparatuses is to be fallen within 30 ms in order to implement the path switching within time period of 50 ms. In the meantime, since a failure of the MP2MP network N1 side may be solved by the processing of the STP, the communication system 1 may be regarded as being equipped with, for example, RSTP (Rapid Spanning Tree Protocol) with which more rapid path switching may be implemented. However, even when the RSTP is used, the communication system 1 normally requires two to three seconds at the maximum for the switching processing.

In the communication system 1, the path management frame generation unit 12d of the communication apparatus 10 may be adapted to update the path management frame P at a predetermined time interval (e.g., 10 ms). Further, the path management frame generation unit 22d of the communication apparatus 20 may be adapted to update the path management frame P at a predetermined time interval (e.g., 10 ms). Accordingly, since the path management frame P used for the path switching processing is periodically updated based on the monitored result of the redundant paths, the communication system 1 may transmit the frame at all times based on the path switching control in which the newest path status is reflected. Further, each of the path management frame generation units 12d and 22d of the communication apparatuses 10 and 20 may synchronize the timing, at which the path management frame P is periodically updated, between the communication apparatuses 10 and 20. Accordingly, occurrence of a time lag is prevented and the path switching control may be made with a higher precision based on the newest path status.

Further, when a failure occurs in one relaying apparatus, the path management frame P which has been periodically received is not received in the other relaying apparatus. In this case, the other relaying apparatus determines that a failure has occurred and performs the path switching. As described above, in the communication system 1, the path management frame P may be periodically transmitted through the apparatus redundancy connection, so that communications may be continued even when the failure occurs in one of the relaying apparatuses.

In the communication system 1, the OAM termination unit 12c of the communication apparatus 10 may be adapted to allocate the PID, which is an identifier for managing the status of the path accommodated in the communication apparatus 10 and the communication apparatus 20 for each redundant path, to the path information contained in the path management frame P. Further, the OAM termination unit 22c of the communication apparatus 20 may be adapted to allocate the same PID (e.g., 5) as the PID described above to the path information contained in the path management frame P. Further, the path redundancy switching control unit 11c of the communication apparatus 10 may be adapted to allocate the path to be used for transmitting the frame based on each path information (e.g., PF0 to PF3 of FIG. 9A) associated with the PID. Accordingly, the communication system 1 becomes to be able to cope with the redundant paths (e.g., active path P1 and standby path P2) using the PID to easily cope with the increase of the redundant paths accommodated in each of the communication apparatuses 10 and 20.

In the communication system 1, the path management frame P may include the PID information which is the path information having a format which is common to different types of hardware. Accordingly, since the path information contained in each path management frame P has the common format, the communication system 1 may reduce a data size of the path management frame P. As a result, a high-speed frame transmission may be maintained.

Further, in the embodiment described above, a case is assumed that a failure has occurred in one of the redundant paths (active path P1 or standby path P2) among multiple redundant paths (e.g., 8192 redundant paths) accommodated in the communication system 1. However, the communication system 1 is able to cope with a case where failures substantially simultaneously occur in a plurality of redundant paths. That is, when a plurality of failures occur, the communication system 1 automatically updates each of the PID tables 12e and 22e of the IF cards 12 and 22 by hardware due to the detection of the receiving end of each OAM frame. Further, information of each of the redundant path status management tables 11d and 21d of the IF cards 11 and 21 is also automatically updated by the hardware between the redundant apparatuses. In FIG. 7, the redundant path status management table 21d is represented as the shortened form of “RPSMTB” 21d. Therefore, the communication system 1 becomes able to substantially simultaneously perform multiple paths switching without imposing a processing load on each of the CPU units 11f, 12f, 21f and 22f or each of the CPU cards 15 and 25a of the communication systems 10 and 20. In FIG. 7, the CPU unit 21f and the CPU unit 22f are represented as the shortened form of “CPUN” 21f and “CPUN” 22f, respectively.

Further, in the above embodiment, a frame is assumed as a PDU (Protocol Data Unit) used for a path management or a data transfer, but the PDU is not limited to the frame. For example, the embodiment may be applied to other PDU such as, for example, TCP/IP (Transmission Control Protocol/Internet Protocol) packet or ATM (Asynchronous Transfer Mode) cell according to the type of network. Further, descriptions have been made on the apparatus redundancy connection between the networks providing different types of services in the embodiment. However, the embodiment may be applied to the connection between networks having, for example, different configurations, protocols, topologies, layers or scale. Especially, the network topology is not limited to a ring type and the network may be a mesh type network, star type network, bus type network, tree type network or a network having a topology in which these connection types are combined.

Further, in the embodiment, a transfer time interval of the OAM frame of 3.3 ms has been described according to the standardization technology, but the transfer time interval of the OAM frame is not limited thereto and may be, for example, about 2 ms. Accordingly, the communication system 1 may further shorten the update time interval of the PID table 12e. Further, a time period that the path management frame generation unit 12d reads-out the PID table 12e is not limited to approximately 10 ms, but may be, for example, about 6 ms. Accordingly, the communication system 1 may further shorten the generation time interval and the transfer time interval of the path management frame P or the update time interval of the redundant path status management table 11d. As a result, the high-speed path switching processing is further improved upon detection of the failure.

Further, the number of redundant paths accommodated in the communication system 1 is not limited to two paths including the active path P1 and the standby path P2, but may be three paths. Also, the number of redundant apparatuses is not limited to two apparatuses including the communication apparatuses 10 and 20, but may be three or more apparatuses.

Further, in the embodiment, a series of processing from the path status monitoring to the frame transfer control are performed by hardware equipped in each of the communication apparatuses 10 and 20. The hardware may be, for example, a FPGA (Field Programmable GateArray), but is not limited thereto and may be a NPU (Network Processing Unit).

Further, in the embodiment, each constitutional element of the communication system 1 is not necessarily the same as its physical configuration as illustrated. That is, a specific distribution and/or integration aspect of respective apparatuses is not limited to one illustrated, and all or some of the respective apparatuses may be configured to be functionally or physically distributed or integrated in any unit according to, for example, various loads or use situation. For example, the reception frame processing unit 12a and the OAM termination unit 12c of the IF card 12 and the path redundancy switching control unit 11c and the path management frame extraction unit 11e of the IF card 11 illustrated in FIG. 7 may be integrated in a single component, respectively. Otherwise, it may be configured such that the OAM termination unit 12c includes the PID table 12e and the path redundancy switching control unit 11c includes the redundant path status management table 11d. Further, in contrast, the SW unit 14a of the SW card 14 may be divided into, for example, a portion which transfers the generated path management frame P to an IF card other than the generation source IF card and another portion which transfers frames received from networks N1 and N2 to different communication apparatus destinations. Further, a memory maintaining various tables included in the communication system 1 may be connected to the communication apparatuses 10 and 20 via a network or cable as an external apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first communication apparatus configured to connect a first path of a first network with a second network; and
a second communication apparatus configured to connect a second path of the first network with the second network,
wherein the first communication apparatus is configured to notify the second communication apparatus of a status of the first path, and
wherein the second communication apparatus is configured to transfer, to the second network, data transferred on the second path, based on the notified status of the first path.

2. The communication system according to claim 1, wherein the first network has a point to point (P2P) connectivity architecture.

3. The communication system according to claim 1, wherein the second network has a multi-point to multi-point (MP2MP) connectivity architecture.

4. The communication system according to claim 1,
wherein the first communication apparatus is configured to notify the second communication apparatus of the status of the first path at a specific time interval, and
wherein the second communication apparatus is configured to transfer, to the second network, the data transferred on the second path when the status of the first path is not received at the specific time interval.

5. The communication system according to claim 1,
wherein the first communication apparatus includes:
a first monitoring unit configured to monitor the status of the first path, and
a communication unit configured to transmit a monitored result by the first monitoring unit to the second communication apparatus, and
wherein the second communication apparatus includes:
a second monitoring unit configured to monitor the status of the second path, and
a termination unit configured to receive the monitored result transmitted by the communication unit and to terminate the second path based on the corresponding monitored result and a monitored result by the second monitoring unit.

6. The communication system according to claim 5,
wherein the first communication apparatus further includes
a first generation unit configured to generate a first path management information indicating the status of the first path based on the monitored result,
wherein the second communication apparatus further includes:
a second generation unit configured to generate a second path management information indicating the status of the second path based on the monitored result, and
the termination unit is configured to transmit the second path management information generated by the second generation unit to the first communication apparatus, and
wherein the first communication apparatus further includes:
a determination unit configured to determine any one of the first path and the second path as a path used for transmitting a frame, based on the first path management information and the second path management information, and
the communication unit is configured to transmit the frame to the path determined by the determination unit.

7. The communication system according to claim 6,
wherein the first generation unit is configured to update the first path management information at a specific time interval, and
wherein the second generation unit is configured to update the second path management information at the specific time interval.

8. The communication system according to claim 6,
wherein the first monitoring unit is configured to allocate an identifier used for managing a status of the path connected to the first communication apparatus and the second communication apparatus for each redundant path, into first path information included in the first path management information,
wherein the second monitoring unit is configured to allocate an identifier which is the same as the identifier to second path information included in the second path management information, and
wherein the determination unit is configured to determine the path used for transmitting the frame, based on the first path information and the second path information that are associated with the identifier.

9. The communication system according to claim 6, wherein each of the first path management information and the second path management information includes a path information having a format common to the first communication apparatus and the second communication apparatus.

10. The communication system according to claim 5, wherein the first network is the P2P network being connected with the second network through the first communication apparatus and the second communication apparatus which have mutually a redundancy configuration.

11. The communication system according to claim 6, wherein the determination unit is configured to determine the path used for transmitting the frame by autonomous processing of hardware without software processing.

12. The communication system according to claim 6, wherein each of the first path management information and the second path management information is a frame having a priority higher than other information frame as a priority upon transmitting the frame.

13. The communication system according to claim 6, wherein each of the first path management information and the second path management information is a frame having a priority of the highest class as a priority upon transmitting the frame.

14. The communication system according to claim 6, wherein each of the active path management information and the standby path management information is a frame for a multicast transfer as a type of frame transmission.

15. A communication apparatus is any one of a first communication apparatus and a second communication apparatus,
the first communication apparatus comprising:
a first reception unit configured to receive data transferred on a first path of a first network;
a first notification unit configured to notify the second communication apparatus connecting a second path of the first network with a second network of the status of the first path; and
a first transmission unit configured to transfer the received data to the second network, and
the second communication apparatus comprising;
a second reception unit configured to receive data transferred on the second path of the first network;
a second notification unit configured to be notified of the status of the first path from the first communication apparatus connecting the first path of the first network with the second network; and
a second transmission unit configured to transfer the data transferred on the second path to the second network, based on the notified status of the first path.

16. A path switching method to switch a path between a first network and a second network through a first communication apparatus connecting a first path of the first network with the second network and a second communication apparatus connecting a second path of the first network with the second network, the path switching method comprising:
notifying, by the first communication apparatus, the second communication apparatus of a status of the first path; and
transferring, by the second communication apparatus, data transferred on the second path to the second network, based on the notified status of the first path.
